(19) United States
(12) Patent Application Publication
(10) Pub. No.: US 2019/0352802 A1
(43) Pub. Date: Nov. 21, 2019

(54) PHOTOLUMINESCENT ELECTROSPUN FIBERS

(71) Applicant: SINGAPORE UNIVERSITY OF TECHNOLOGY AND DESIGN, Singapore (SG)

(72) Inventors: Franklin ANARIBA, Singapore (SG); Mushtaq SOBHAN, Singapore (SG)

(21) Appl. No.: 16/481,328

(22) PCT Filed: Jan. 24, 2018
(86) PCT No.: PCT/SG2018/050043

§ 371 Date: Jul. 26, 2019

(30) Foreign Application Priority Data
Jan. 26, 2017 (SG) 10201700704V

(51) Int. Cl. D01D 5/00; C09K 11/06

(52) U.S. Cl. CPC D01D 5/003; D10B 2321/10; C09K 11/06

(57) ABSTRACT

An electrospun fibre comprising: a polymer matrix; and a plurality of photoluminescent molecules in the polymer matrix, wherein each photoluminescent molecule comprises a hydrophobic portion and a charged portion. A method for producing an electrospun fibre, the method comprising: preparing a polymer matrix; adding a plurality of photoluminescent molecules to the polymer matrix to form a spinable solution, each photoluminescent molecule comprises a hydrophobic portion and a charged portion; and electrospinning the spinnable solution to produce the electrospun fibre. An example of the photoluminescent molecule is 1-(1-(8-pyridiniumoctyloxy)-2, 3,4,5-tetraphenylcyclopenta-2,4-dienyl)benzene chloride (structure shown below), a molecule having aggregation-induced emission (AIE) properties.

### BACKGROUND OF THE INVENTION

Luminogens have gained tremendous interest because of their applicability in the fabrication of solid state emitters, such as organic light emitting diodes (OLED), required in display applications. However, traditional luminogens suffer from aggregation-induced quenching (AIQ) in the solid state form, mostly due to the formation of excimers and exciplexes species. Consequently, traditional luminogens have found limited applications in display devices because of its low dispersed concentration in films, providing inherently weak signals. In order to overcome this challenge, one strategy has been to chemically tailor luminogenic pendants to the backbone of polymers, refining polymeric architectures and granting optical capabilities, independent of conjugation as is the case in radical polymers.¹ Another strategy has been to synthetically modify polymeric backbones with pendants exhibiting aggregation-induced emission (AIE) properties.²⁻³

Recently, the fabrication of optical and electronic polymeric materials has been achieved through the use of the electrospinning technique, mainly due to its low cost and maintenance, flexible parametric tuning, green chemistry (use of small amounts of solvent), and high throughput.⁴ One approach for the preparation of optical polymeric materials has been to electrospin polymer blends⁵, such as polyfluorene derivatives/poly(methyl) methacrylate (PMMA) and phenylene vinylene derivatives/PMMA, using a single solution spinneret for the purpose of reducing AIQ to enhance luminescence efficiency. Results show an improved luminescence yield in comparison to spin casted thin films, attributed to uniformed distribution due to geometrical constraints during the electrospinning process.⁶⁻⁷ In another approach, polymeric materials have been synthetically modified with AIE-active pendants and subsequently electrospun⁸⁻⁹ into flexible solid state emitters¹⁰, bacterial sensor¹¹, and for oil adsorption.¹²

In a different approach, inorganic germanium nanocrystals have been incorporated into electrospun polymeric fibers, resulting in fiber webs with unique optical properties rivalling solution photoluminescence.¹³⁻¹⁴ Similarly, CdSe, CdS, and ZnS quantum dots (QD) have been incorporated into electrospun poly(9-vinylcarbazole) matrices to produce uniformed orange and red color solid state mat emitters with superior luminescence than thin films, reducing QD aggregation and its quenching effects. These mats were subsequently used along luminogen C545T¹⁵ to fabricate white light OLEDs.^{15,16,17}

### SUMMARY OF THE INVENTION

In a first aspect, there is provided an electrospun fibre comprising: a polymer matrix; and a plurality of photoluminescent molecules in the polymer matrix, wherein each photoluminescent molecule comprises a hydrophobic portion and a charged portion.

Preferably, the photoluminescent molecule further comprises a hydrophilic portion, the charged portion is hydrophilic or hydrophobic.

The term “photoluminescent molecule” refers to compounds which exhibit photoluminescent properties, in particular those via an aggregation induced emission. The term “hydrophobic” and “hydrophilic” means tending to repel and attract water respectively, and must be understood contextually with respect to the whole molecule. The term “portion” refers to a part of the molecule.

Preferably, the hydrophobic portion has a general Formula (I):

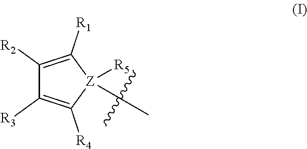

wherein R₁, R₂, R₃, and R₄ is each independently an aryl group, a substituted aryl group, a heteroaryl group, or a substituted heteroaryl group; R₅ is an aryl group, a substituted aryl group, a heteroaryl group, a substituted heteroaryl group, a hydrogen or an alkyl group; and Z is carbon or silicon.

The term “aryl group” used alone or as part of a larger moiety as in “aralkyl”, “aralkoxy”, or “aryloxyalkyl”. The term “aromatic group” may be used interchangeably with the terms “aryl”, “aryl ring” “aromatic ring”, “aryl group” and “aromatic group”. A “substituted aryl group” is substituted at any one or more substitutable ring atom.

The term “heteroaryl”, “heteroaromatic”, “heteroaryl ring”, “heteroaryl group” and “heteroaromatic group”, used alone or as part of a larger moiety as in “heteroaralkyl” or “heteroarylalkoxy”, refers to aromatic ring groups having five to fourteen ring atoms selected from carbon and at least one (typically 1-4, more typically 1 or 2) heteroatom (e.g., oxygen, nitrogen or sulfur). They include monocyclic rings and polycyclic rings in which a monocyclic heteroaromatic ring is fused to one or more other carbocyclic aromatic or heteroaromatic rings. Examples of monocyclic heteroaryl groups include furanyl (e.g., 2-furanyl, 3-furanyl), imidazolyl (e.g., N-imidazolyl, 2-imidazolyl, 4-imidazolyl, 5-imidazolyl), isoxazolyl(e.g., 3-isoxazolyl, 4-isoxazolyl, 5-isoxazolyl), oxadiazolyl (e.g., 2-oxadiazolyl, 5-oxadiazolyl), oxazolyl (e.g., 2-oxazolyl, 4-oxazolyl, 5-oxazolyl), pyrazolyl (e.g., 3-pyrazolyl, 4-pyrazolyl), pyrrolyl (e.g., 1-pyrrolyl, 2-pyrrolyl, 3-pyrrolyl), pyridyl (e.g., 2-pyridyl, 3-pyridyl, 4-pyridyl), pyrimidinyl (e.g., 2-pyrimidinyl, 4-pyrimidinyl, 5-pyrimidinyl), pyridazinyl (e.g., 3-pyridazinyl), thiazolyl (e.g., 2-thiazolyl, 4-thiazolyl, 5-thiazolyl), triazolyl (e.g., 2-triazolyl, 5-triazolyl), tetrazolyl (e.g., tetrazolyl) and thienyl (e.g., 2-thienyl, 3-thienyl. Examples of monocyclic six-membered nitrogen-containing heteroaryl groups include pyrimidinyl, pyridinyl and pyridazinyl. Examples of polycyclic aromatic heteroaryl groups include carbazolyl, benzimidazolyl, benzothienyl, benzofuranyl, indolyl, quinolinyl, benzotriazolyl, benzothiazolyl, benzoxazolyl, benzimidazolyl, isoquinolinyl, indolyl, isoindolyl, acridinyl, or benzisoxazolyl. A “substituted heteroaryl group” is substituted at any one or more substitutable ring atom.

The term “substituted” shall mean the replacement of one or more hydrogen atoms in a given structure with a substituent including, but not limited to, halo, alkyl, alkenyl, alkynyl, aryl, heterocyclyl, thiol, alkylthio, arylthio, alkylthioalkyl, arylthioalkyl, alkylsulfonyl, alkylsulfonylalkyl, arylsulfonylalkyl, alkoxy, aryloxy, aralkoxy, aminocarbonyl, alkylaminocarbonyl, arylaminocarbonyl, alkoxycarbonyl, aryloxycarbonyl, haloalkyl, amino, trifluoromethyl, cyano, nitro, alkylamino, arylamino, alkylaminoalkyl, arylaminoalkyl, aminoalkylamino, hydroxy, alkoxyalkyl, carboxyalkyl, alkoxycarbonylalkyl, aminocarbonylalkyl, acyl, aralkoxycarbonyl, carboxylic acid, sulfonic acid, sulfonyl, phosphonic acid, aryl, heteroaryl, heterocyclic, or aliphatic. It is understood that the substituent may be further substituted.

The term “alkyl” used alone or as part of a larger moiety, such as alkoxy, haloalkyl, arylalkyl, alkylamine, cycloalkyl, dialkyamine, alkylamino, dialkyamino alkylcarbonyl, alkoxycarbonyl and the like, includes as used herein means saturated straight-chain, cyclic or branched aliphatic group. As used herein, a C1-C6 alkyl group is referred to as “lower alkyl.” Similarly, the terms lower alkoxy, lower haloalkyl, lower arylalkyl, lower alkylamine, lower cycloalkylalkyl, lower dialkyamine, lower alkylamino, lower dialkyamino, lower alkylcarbonyl, lower alkoxycarbonyl include straight and branched saturated chains comprising one to six carbon atoms.

More preferably, R₅ is an aryl group, a substituted aryl group, a heteroaryl group, or a substituted heteroaryl group. Advantageously, this increases the hydrophobicity and restricts the rotation of the other substituents.

More preferably, the aryl group is a phenyl group. In an embodiment, R₁ to R₅ is a phenyl group.

More preferably, the charged portion is a pyridinium cation. The pyridinum cation need not be attached to the linker or hydrophobic portion through the nitrogen atom, and may be further substituted, and still be considered a pyridinium cation.

More preferably, the photoluminescent molecule further comprises a counterion to the charged portion.

Preferably, there is a linker to attach the hydrophobic portion to the charged portion, wherein the linker is any one selected from the group comprising: —X(CH₂)ₙ—, —X(CH₂)ₙY—, —(CH₂)ₙ—, and —(XCH₂CH₂)ₙ—, wherein n is an integer from 3 to 20, X and Y may each be independently oxygen, nitrogen or sulphur. In particular, X and/or Y may be oxygen. In some embodiments, the linker may be hydrophilic.

Preferably, the polymer matrix comprises any polymer selected from the group comprising: polyvinylpyrrolidone, poly(N-isopropylacrylamide), poly(vinylidene fluoride)-co-hexafluoropropylene, and poly(methyl methacrylate).

Preferably, the plurality of photoluminescent molecules form an aggregate nanoparticle having a diameter between about 5 to 800 nm.

Preferably, the weight ratio of the plurality of photoluminescent molecules to the polymer is about 1:1875 to about 1:75.

Preferably, the electronspun fibre further comprises epoxy.

Preferably, the plurality of photoluminescent molecules exhibit a fluorescence half-life greater than or equal to one nanosecond.

Preferably, the plurality of photoluminescent molecules exhibit a phosphorescence half-life greater than or equal to one microsecond.

In a second aspect, there is provided a method for producing an electrospun fibre, the method comprising: preparing a polymer matrix; adding a plurality of photoluminescent molecules to the polymer matrix to form a spinnable solution, each photoluminescent molecule comprises a hydrophobic portion and a charged portion; and electrospinning the spinnable solution to produce the electrospun fibre.

Preferably, the polymer matrix and plurality of photoluminescent molecules are mixed in a solvent to prepare the spinnable solution.

Preferably, the plurality of photoluminescent molecules are mixed in a solvent prior to being added into the polymer matrix.

More preferably, the polymer matrix is in a second solvent.

Preferably, the solvent and/or second solvent is an organic solvent, water, or a combination of an organic solvent and water. The solvent or solvent combination used should be electrospinnable.

More preferably, the organic solvent is any one selected from the group comprising: DMSO, DMF, acetone, and an alcohol. Any suitable solvent may be used to achieve an electrospinnable solution. Such a solution should have the appropriate viscosity and ability to take charge on the surface of the solution.

Preferably, the polymer matrix is polyvinylpyrrolidone and the spinable solution is in ethanol.

Preferably, the spinable solution in step (b) is stirred for 30 minutes to 24 hours at a temperature between 20° C. to 100° C.

More preferably, the temperature is between 20° C. to 50° C. Alternatively, higher temperatures such as 80° C. or up to 120° C. may be used to dissolve the solute without affecting its molecular structure.

Preferably, the method further comprising drying the electrospun fibre.

Preferably, the drying is carried out in an oven at 60° C. for 2 hours.

The electrospun fibre and method of fabrication eliminates the need to tether AIE-active pendants into polymeric backbones by chemical means, thus tremendously decreasing preparation time while minimizing potential solubility concerns. The method is applicable to different photoluminescent molecules and polymer matrices allowing the preparation of electrospun fibres with different photoluminescence properties. The use of a charged portion in the photoluminescent molecule may advantageously improve the electrospinning process and the electrospun fibre.

In the Figures:

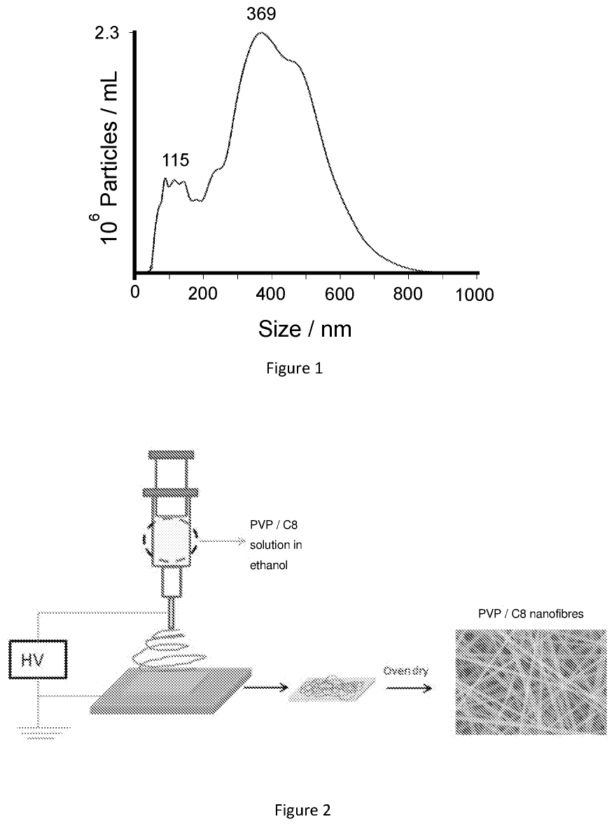

FIG. 1 shows a nanoparticle tracking analysis of C8 in ethanol, wherein the size distribution is bimodal and highly heterogeneous, ranging from about 50 to 800 nm;

FIG. 2 shows a set up for the fabrication of photoluminescent nanofibres using C8 dissolved in ethanol;

FIG. 3 shows scanning electron microscopy (SEM) images of the electrospun PVP/C8 nanofibers with a diameter size of ranging from 300 to 500 nm;

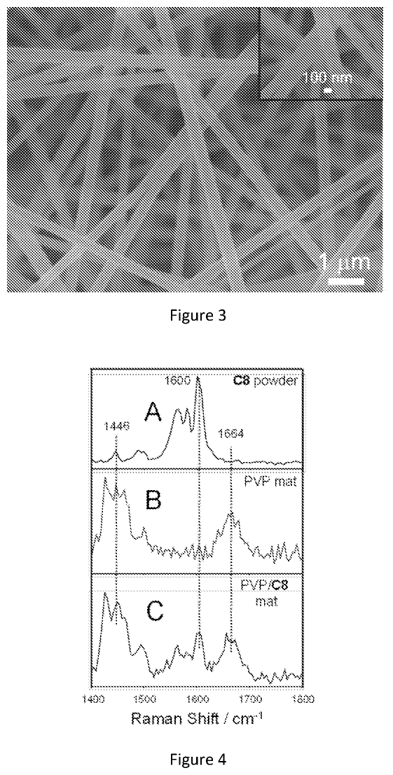

FIG. 4 shows the Raman spectra of (A) C8 powder, (B) PVP nanofiber mat, and (C) PVP/C8 nanofiber mat;

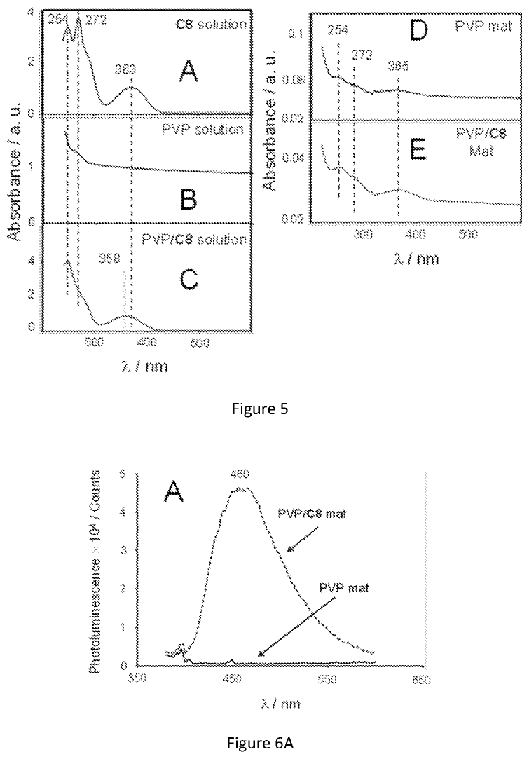

FIG. 5 shows the UV-Vis solution spectra of (A) C8 ethanol solution, (B) PVP ethanol solution, and (C) PVP/C8 ethanol solution. UV-Vis reflectance spectra of electrospun (D) PVP nanofiber mats, and (E) PVP/C8 nanofibers mats;

FIG. 6A shows the photoluminescent spectra of electrospun PVP and PVP/C8 nanofiber mats with λₑₓ=360 nm;

FIG. 6B shows the fluorescence microscope images and mean fluorescence intensity of (A) PVP nanofiber mats and (B) PVP/C8 nanofiber mat; the mean intensity was probed randomly and its average and standard deviation corresponds to N=15, visible as circles in the upper fluorescence images;

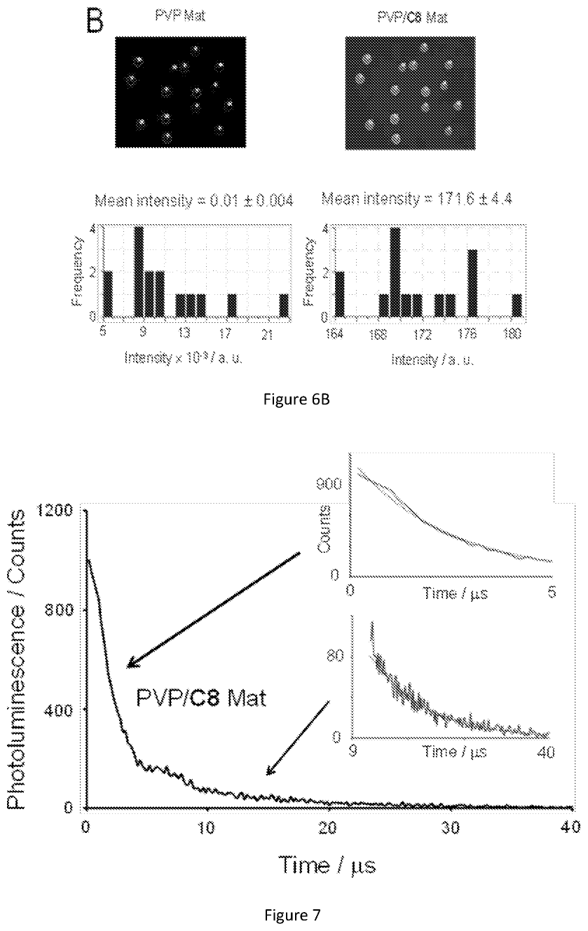

FIG. 7 shows the photoluminescent decay curve of the electrospun PVP/C8 nanofiber mats; upper inset is the exponential fit for the fast relaxation pathway (τ₁), while lower inset is the exponential fit for the slow relaxation pathway (τ₂);

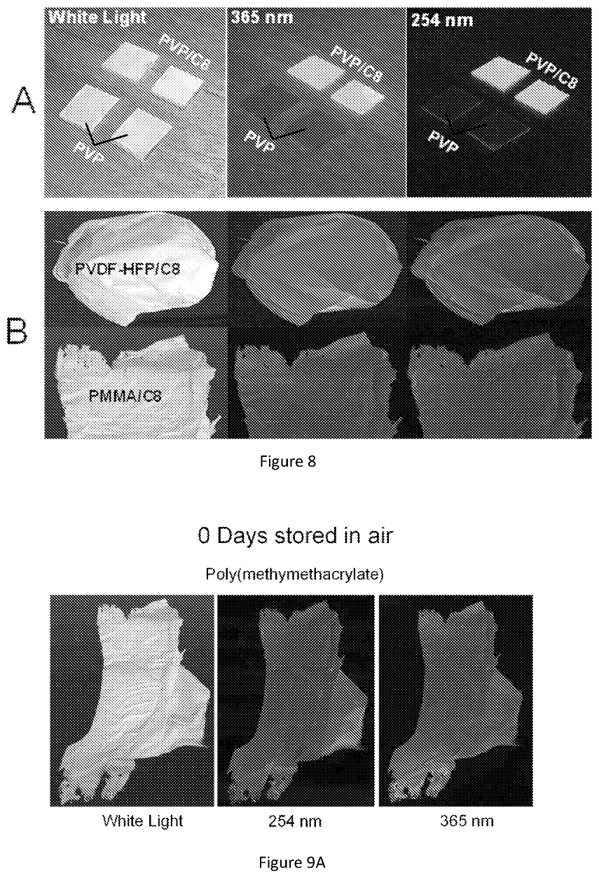

FIG. 8 shows (A) digital photographs of irradiated PVP and PVP/C8 nanofibers mats on a glass substrate under white light, 365 nm, and 254 nm excitation wavelength, respectively (note that both PVP and PVP/C8 nanofiber mats are white in colour, indicating that the luminogen concentration used was insufficient to add colour); (B) photoluminescent electrospun mats synthesised under various solvents and polymeric matrices; the top panel exhibits PVDF-HFP/C8 synthesized out of a mixture of DMF/acetone solution and the bottom panel displays PMMA/C8 electrospun out of a DMF solution.

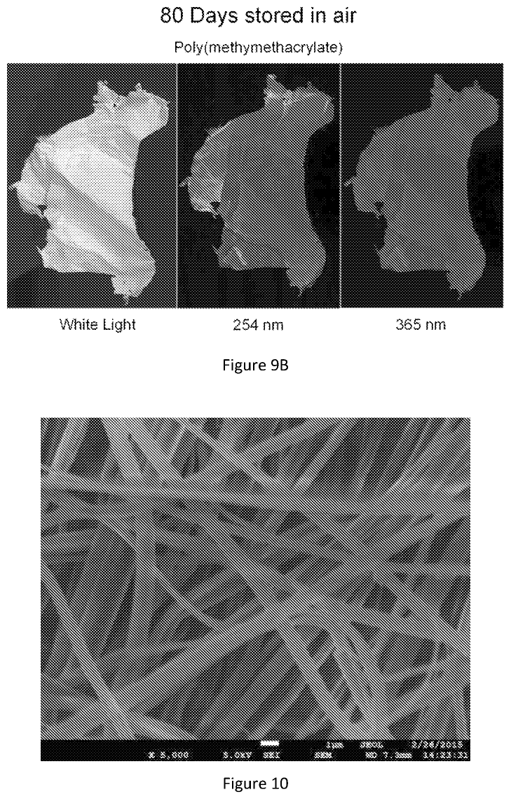

FIGS. 9A and 9B shows the luminescence of electrospun fibre containing PMMA and C8 at 0 days and 80 days respectively;

FIG. 10 shows a SEM image of electrospun nanofibres from a spinnable solution containing poly(N-isopropylacrylamide) polymer and C8 molecules in ethanol;

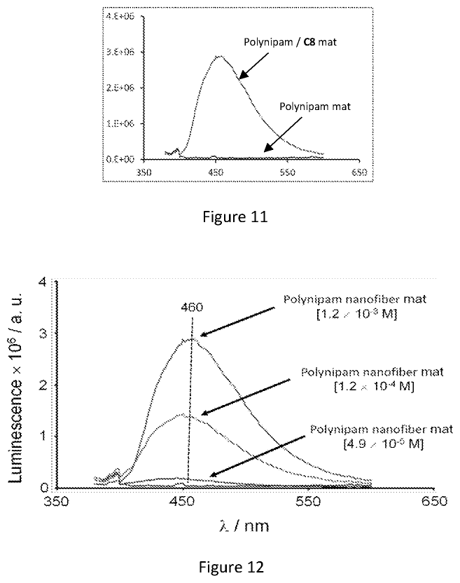

FIG. 11 shows the photoluminescent curves of the electrospun nanofibres in the presence and absence of C8 in poly(N-isopropylacrylamide) polymer (polynipam);

FIG. 12 shows photoluminescent curves of electrospun nanofibres from a spinnable solution containing poly(N-isopropylacrylamide) polymer and C8 molecules in ethanol at various concentrations of the polymer and the correlation of photoluminescence to the concentration of C8 and the polymer.

### DETAILED DESCRIPTION

Where a range of values is recited, it is to be understood that each intervening integer value, and each fraction thereof, between the recited upper and lower limits of that range is also specifically disclosed, along with each subrange between such values. The upper and lower limits of any range can independently be included in or excluded from the range, and each range where either, neither or both limits are included is also encompassed within the invention. Where a value being discussed has inherent limits, for example where a component can be present at a concentration of from 0 to 100%, or where the pH of an aqueous solution can range from 1 to 14, those inherent limits are specifically disclosed. Where a value is explicitly recited, it is to be understood that values which are about the same quantity or amount as the recited value are also within the scope of the invention, as are ranges based thereon. Where a combination is disclosed, each subcombination of the elements of that combination is also specifically disclosed and is within the scope of the invention. Conversely, where different elements or groups of elements are disclosed, combinations thereof are also disclosed. Where any element of an invention is disclosed as having a plurality of alternatives, examples of that invention in which each alternative is excluded singly or in any combination with the other alternatives are also hereby disclosed; more than one element of an invention can have such exclusions, and all combinations of elements having such exclusions are hereby disclosed.

In order that the present invention may be fully understood and readily put into practical effect, there shall now be described by way of non-limitative examples only preferred embodiments of the present invention, the description being with reference to the accompanying illustrative figures.

A new approach is used in the fabrication of photoluminescent electrospun polymeric nanofibers. The electrospun fibre comprises a polymer matrix and a plurality of photoluminescent molecules in the polymer matrix. Each photoluminescent molecule comprises a hydrophobic portion and a charged portion. The hydrophobic portion and the charged portion are attached together, and preferably by a linker. The charged portion may be hydrophobic or hydrophilic. In an embodiment, the portion is neutral but is hydrophilic in nature.

The hydrophobic portion has a general formula (I):

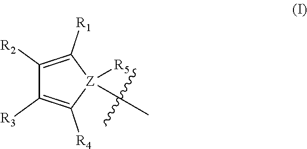

wherein R₁, R₂, R₃, and R₄ is each independently an aryl group, a substituted aryl group, a heteroaryl group, or a substituted heteroaryl group; R₅ is an aryl group, a substituted aryl group, a heteroaryl group, a substituted heteroaryl group, a hydrogen or an alkyl group; and Z is carbon or silicon. Z is preferably carbon, i.e. the hydrophobic portion is a cyclopentadiene head. R₅ is preferably an aryl group, a substituted aryl group, a heteroaryl group, or a substituted heteroaryl group. This further increases the hydrophobicity of the hydrophobic portion. The presence of a bulky group at R5 may also contribute to the photoluminescent properties by restricting the conformation of the hydrophobic portion and/or photoluminescent molecule in general.

The hydrophobic portion is attached to the portion at the atom Z. A linker is preferably used to attach the portion to the hydrophobic portion, and may advantageously aid the aggregation of the photoluminescent molecules. The portion may be hydrophilic, and is preferably charged. Alternatively, the portion may be a hydrophobic charged portion. The presence of the charged portion may aid in the electrospinning process to produce the fibres in better quality and more efficiently.

The charged portion may be cationic or anionic, and the photoluminescent molecule may further have a counterion to maintain neutrality, i.e. the counterion has an opposite charge to the charged portion. An example of a cationic charged portion is a pyridinium cation. The pyridinium cation may be attached to the hydrophobic portion and the linker if present via the nitrogen or carbon atom of the pyridinium cation. The pyridinium cation may be further substituted. Another example is a quaternary ammonium cation. When the charged portion is a cation, the counterion is anionic. Examples of an anionic counterion include a halide, tosylate, mesylate, and triflate. Exemplary halides include fluoride, chloride, bromide, and iodide. The preceding examples are typical leaving groups and may be further exchanged with other counterions, for example boron and phosphorous based anions (e.g. BF₄⁻, B(Ph)₄⁻, and PF₆⁻).

The linker may be designed or modified as necessary, in particular to modify the solubility of the photoluminescent molecule. The modified linker may include any one selected from the group comprising: —X(CH₂)ₙ—, —X(CH₂)ₙY—, —(CH₂)ₙ—, and —(XCH₂CH₂)ₙ—, wherein n is an integer from 3 to 20, and X and Y is independently oxygen (O), nitrogen (N) or sulphur (S). In particular, X and Y is oxygen.

An example of a photoluminescent molecule is 1-(1-(8-pyridiniumoctyloxy)-2,3,4,5-tetraphenylcyclopenta-2,4-dienyl)benzene chloride¹⁸ (C8), the preparation of which is described in Reference 18 and incorporated herein by reference. C8 comprises a cyclopentadiene head with five phenyl groups, and a pyridiunium portion bridged by an 8-carbon alkoxy chain. C8 is incorporated into the polymeric matrix via an electrospinning method.

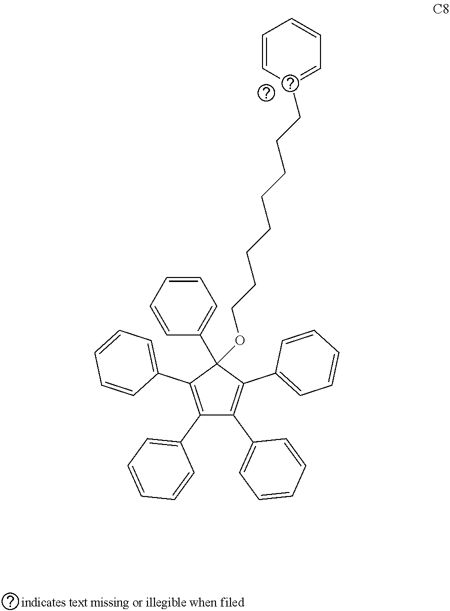 [SMILES: c1ccc(CCCCCCCCOC2(c3ccccc3)C(c3ccccc3)=C(c3ccccc3)C(c3ccccc3)=C2c2ccccc2)cc1]

When C8 is dissolved in ethanol, the molecules aggregate into nanoparticles. The particle size analysis of the C8 molecules in ethanol was obtained using a nanoparticle size analyser instrument (Nanosight NS300). FIG. 1 shows the nanoparticle tracking analysis of C8 in ethanol. The C8 molecules dissolved in ethanol displayed a heterogeneous size aggregation distribution ranging from about 50 nm to 800 nm with two noticeable peak at 115 and 369 nm (a bimodal distribution), as shown in FIG. 1. It is believed that the aggregated photoluminescent molecules exhibit photoluminescence properties due to the aggregation-induced emission (AIE) behaviour of the photoluminescent molecules.

Examples of polymers that may be used as the polymer matrix includes polyvinylpyrrolidone (PVP), poly(N-isopropylacrylamide), poly(vinylidene fluoride)-co-hexafluoropropylene (PVDF-HFP), and poly(methyl methacrylate) (PMMA), the formula of which are shown.

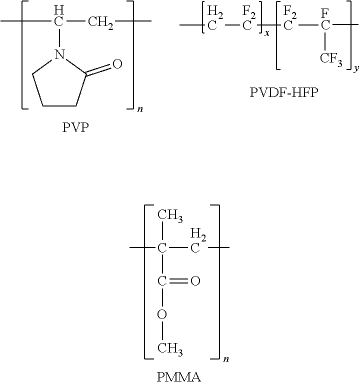

To prepare the electrospun fibre, a polymer matrix and a plurality of photoluminescent molecules as described above are mixed to form a spinnable solution. The mixing of the polymer and photoluminescent molecules may be achieved in different ways. For example, the polymer and photoluminescent molecules are each dissolved in a solvent before being mixed to form a spinnable solution. The solvent should be electrospinnable regardless of the solvent or solvent combination. The solvent should preferably have the appropriate viscosity and ability to take charge/s on the surface the solution. The solvent may be the same or be different solvents. In another example, the polymer may be first dissolved in a solvent to form a polymer solution to which the photoluminescent molecules are added, or vice versa. In another example, the polymer and photoluminescent molecules are added together to a solvent.

The solvent used may be an organic solvent, water, or a combination of solvents (i.e. a combination of two or more organic solvents, or a combination of an organic solvent/s and water). Examples of organic solvent that may be used include dimethylsulfoxide (DMSO, dimethylformamide (DMF), acetone, and an alcohol. Preferably, the alcohol is a short chain alcohol, for example methanol, ethanol, 1-propanol, 2-propanol, 1-butanol, 2-butanol, and t-butanol.

The solvent and solvent ratio used depends on the solubility of the solute in the solution. It may be determined experimentally, or theoretically calculated and preferably confirmed experimentally. By modifying the variables in the electrospinning process, like the solvent and/or solvent ration, it may be possible to produce electrospun fibres from various different solvents.

The mixing of the polymer and photoluminescent molecules is preferably by stirring the polymer and photoluminescent molecules in the solvent for 30 minutes to 24 hours at a temperature between 20° C. to 100° C. The stirring temperature may be further kept between 20° C. to 50° C.

The spinable solution formed is subsequently subjected to electrospinning to produce the electrospun fibre. The electrospun fibre may be further dried, preferably in an oven at 60° C. for 2 hours.

The electrospun fibres may be further protected with epoxy (any type of polyepoxide resin). This makes the fibres more stable, especially to increase the stable lifetime of the fibres.

### EXAMPLE

### Nanofiber Preparation.

Polyvinylpyrrolidone (PVP), (MW: 130 000 Da), and ethanol (99.9% purity) were purchased from Sigma Aldrich. The PVP solution was prepared by dissolving 0.3 g of PVP in 5 mL of ethanol and stirring at room temperature until the formation of a viscous solution typically for 1 h. Subsequently, 4×10⁻³ g of C8 molecules were added to the above solution and stirred for 30 min to reach a concentration of 1.23×10⁻³ M. The weight ratio of C8 to the PVP polymer is 1:75. The synthesis and solution-based photoluminescence studies of C8 were described before.¹⁸ The resulting PVP/C8 solution was loaded into a plastic syringe equipped with a 21 G needle. A high voltage (HV) of 20 kV was applied between the needle tip and the collector placed at a distance of 13 cm from the needle tip. A typical setup is shown in FIG. 2. The feeding rate for the solution was set at 0.6 mL/h through a syringe pump. The electrospun nanofibers were electrospun for 30 minutes and collected on a glass substrate or an aluminium foil to be subsequently dried in an oven at 60° C. for 2 h. A control sample containing only PVP can be prepared with the same procedure by omitting C8 from the spinable solution.

Alternatively, a similar procedure was used to prepare spinnable solutions for poly(vinylidene fluoride)-co-hexafluoropropylene (PVDF-HFP), and poly(methyl methacrylate) (PMMA) in DMF/acetone (3:1 v/v) and DMF, respectively. In an example, 0.7 g of PMMA and 11.1 mg of C8 was added to 5 mL of dimethylformamide (DMF) to prepare an electrospinnable solution. The solution was spun at a flow rate of 0.5 mL/h and 25 Volts. In another example, approximately 0.5 g of PVDF and 12.0 mg of C8 was dissolved in 5 mL of DMF/acetone (3:1 v/v) to prepare and electrospinnable solution. The solution was spun at a flow rate of 0.9 mL/h and 11 Volts.

The temperature used to dissolve the photoluminescent molecules and/or polymer matrix may be as high as 100° C., without affecting the molecular structure of the photoluminescent molecules in solution. Preferably, the stirring temperature is up to 80° C. (i.e. a stirring temperature of 20° C. to 80° C.). More preferably, the stirring temperature is up to 50° C. (i.e. a stirring temperature of 20° C. to 50° C.). It was determined experimentally that the photoluminescent molecules are affected only above temperatures of 120° C. when embedded in the electrospun nanofibers.

### Nanofiber Mat Characterization.

The electrospun nanofibers comprising polyvinylpyrrolidone and C8 deposited on glass substrates were freshly characterized and subsequently stored in a low humidity environment (Dry cabinet at ˜20% humidity). The morphology of the electrospun nanofiber mats was observed using a scanning electron microscopy (SEM, JEOL JSM-7600 F). The morphology of the electrospun nanofibers is shown in FIG. 3. The nanofibers displayed a diameter range of 300 to 500 nm. At the 30,000 times magnification level (see FIG. 3 inset in upper right corner) the nanofibers showed smooth surfaces without the presence of beads or any other structural features associated with the electrospinning method or as previously reported for a hexaphenylsilole (HPS)/PMMA blend.¹⁹

The distribution and size of the C8 aggregations within the PVP matrix could not be identified at this resolution, especially because C8 molecules dissolved in ethanol displayed a heterogeneous size aggregation distribution ranging from about 50 nm to 800 nm with two noticeable peak at 115 and 369 nm, as shown in FIG. 1.

Structural information of the electrospun nanofiber mats were gathered by Raman spectroscopy. Raman spectra were collected in a NT-MDT confocal Raman microscopic system with excitation laser wavelength of λₑₓ=473 nm, whereby the Si peak at 520 cm⁻¹ was used as a reference for wavenumber calibration.

Raman spectroscopy provided invaluable information on the molecular structure of the electrospun nanofibers and molecular integrity of C8 molecules within the matrix. FIG. 4 shows Raman spectra in the range of 1400-1800 cm⁻¹ for C8 powder (panel A), PVP nanofiber mat (panel B), and PVP/C8 nanofiber mat (panel C). C8 molecules displayed strong Raman-active bands at 1600 cm⁻¹, 1580 cm⁻¹, and 1564 cm⁻¹, and weak bands at 1500 cm⁻¹ and 1446 cm⁻¹ The PVP nanofibers exhibited strong bands at 1664 cm⁻¹, 1462 cm⁻¹, 1446 cm⁻¹, 1426 cm⁻¹, and a weak band at 1500 cm⁻¹. The PVP/C8 nanofiber mats showed peaks at 1664 cm⁻¹, 1604 cm⁻¹, 1580 cm⁻¹, 1564 cm⁻¹, 1495 cm⁻¹, and 1450 cm⁻¹, representing bands associated with C8 molecules and PVP. These results demonstrate that the molecular integrity of C8 molecules was not affected by the electrospinning process, and were instead embedded in nano-aggregate form within the PVP polymeric matrix. This is illustrated by the band at 1600 cm⁻¹ associated with ν(C═C)²⁰ in C8 molecules only, which is nonetheless observed in the PVP/C8 electrospun nanofibers. Similarly, the peak at 1664 cm⁻¹ assigned to ν(C═O)²¹ in the PVP structure is also present in the PVP/C8 nanofiber mats. In contrast, the band at 1446 cm⁻¹, which corresponds to a symmetric ring deformation²², is observed in all three spectra since both PVP and C8 molecules possess rings structures in their molecular structure.

UV-Vis molecular electronic absorption of the solutions and the UV-Vis reflection studies of the nanofiber mats were measured using a UV-Vis spectrophotometer (Perkin Elmer). A UV light source equipped with white light and λₑₓ=254 nm excitation wavelength and a UV lamp with an excitation wavelength of λₑₓ=365 nm were used to irradiate the nanofiber mats to subsequently digitally photograph their luminescence.

The electronic absorption studies for solution and nanofiber mats are shown in FIG. 5. Panels A-C contrasts UV-Vis absorbance spectra for C8, PVP, and PVP/C8 ethanol solutions. AIE-active C8 molecules with a concentration of 1.2×10⁻³ M (used in the PVP and C8 electrospun fibre preparation) showed a strong and broad absorption peak at 363 nm, which is an electronic π-π* transition of the cyclopentadiene ring.²³ The strong absorption bands at wavelength λ=254 nm and λ=272 nm are associated with electronic π-π* transitions of the pyridinium moiety.²⁴ Panel B corresponding to the PVP ethanol solution with a concentration of 4.6×10⁻⁴ M, showed a featureless absorption throughout the spectral range, while the PVP/C8 mixture resembles the spectrum of C8 in ethanol solution in panel A. For the PVP/C8 ethanol solution, the broad band at λ=363 nm has been blue-shifted to λ=358 nm presumably by the presence of the electron donating ability of the nitrogen atom in the PVP structure. The band at λ=272 nm lost intensity and was not discernible, but the peak at λ=254 nm associated with C8 molecules in the ethanol solution was observable.

Panels D and E of FIG. 5 depict the UV-Vis reflectance spectra of the PVP nanofiber and the PVP/C8 nanofiber mats, respectively. In this case, the broad band at λ=365 nm and the peaks at λ=254 nm and λ=272 nm associated with the C8 molecules were clearly visible in the PVP/C8 nanofiber mat spectrum, but absent in the PVP nanofiber mat spectrum. The UV-Vis absorbance studies lend further support to the idea that C8 molecules maintained molecular integrity and remained embedded within the PVP electrospun matrix.

Photoluminescence and lifetime of the nanofibers mats was measured using a fluorescence spectrometer (FSP920, Edinburgh Instruments, Livingston, U.K.). The fluorescence images were produced using a confocal microscope equipped with an excitation filter λ=330-380 nm and a barrier filter at λ=420 nm (Nikon, UV-2A Filter). Digital photographs were taken with the camera of a Sony Experia Z3 hand held phone.

The photoluminescent characteristics of the electrospun PVP/C8 nanofiber mats are shown in FIG. 6A. The observed photoluminescent is in the form of a broad band centred at λₘₐₓ=460 nm and is likely due to the embedded C8 within the polymeric matrix, presumably through nano-aggregations since PVP is non-photoluminescent. Furthermore, the photoluminescent of PVP/C8 nanofiber mats is highly uniformed, as shown in FIG. 6B, whereby fluorescence microscope images of the PVP and PVP/C8 nanofiber mats are presented. The mean intensity provided was probed randomly and its average and standard deviation corresponds to N=15, visible as circles in the upper fluorescence images. The image mean intensity for the photoluminescent PVP/C8 nanofiber mat was calculated to be 171.6±4.4, while the PVP nanofiber mat image mean intensity was 0.01±0.004, amounting to a coefficient of variance of 2.6% and 40% for the PVP/C8 and PVP nanofiber mats, respectively, suggesting the surface of the PVP/C8 electrospun nanofiber mats display remarkably uniformed photoluminescent. These findings strongly indicate that the C8 photoluminescent molecules are uniformly distributed in the PVP polymer matrix and suggests the presence of nano-aggregations within the PVP matrix.

FIG. 7 displays a lifetime photoluminescent curve for the embedded C8 molecules. The time resolved curve is best fitted with a double exponential decay, indicating the presence of two energy relaxation pathways for the excited molecules. A relatively fast relaxation time is shown in the upper inset with τ₁=5 μs (fraction of molecules f₁≅0.85) while the slow relaxation time can be found in the lower inset with τ₂=31 μs (f₂≅0.15). The weighted photoluminescent average was calculated to be τ_{average}=f₁τ₁+f₂τ₂=8.9 μs, which falls in the range of a phosphorescent phenomenon associated with AIE-active molecules, indicating the fabrication process did not affect the emission lifetime. Photoluminescent lifetimes are related to radiative and non-radiative processes. The exact mechanism behind each of the two relaxation pathways is not exactly clear; however, since the radiative lifetime is an intrinsic property of the luminogen, the non-radiative decay mechanism can be modified to become radiative by tailoring the polymer matrix/luminogen interaction, which within the AIE model means inhibiting the phenyl ring vibrational modes. These vibrational modes are restricted/inhibited when the molecules aggregate such that the individual molecules are tightly packed together, restricting the vibrational modes of the phenyl rings.

FIG. 8, in panel A, shows digital photographs of PVP and PVP/C8 nanofiber mats under white light and UV irradiation. The PVP nanofiber mats show no photoluminescent while the PVP/C8 mats exhibit a strong photoluminescence under both λₑₓ=365 nm and λₑₓ=254 nm excitation. FIG. 8 panel B shows electrospun nanofiber mat of poly(vinylidene fluoride)-co-hexafluoropropylene (PVDF-HFP)/C8 formed out of a DMF/acetone spinnable solution (top panel) and electrospun nanofiber mat of poly(methyl methacrylate) (PMMA)/C8 fabricated out of a DMF solution (bottom panel) prepared as described. Similar to panel A, panel B shows the irradiation of the PVDF-HFP/C8 and PMMA/C8 nanofibre mats under white light, and UV (365 nm and 254 nm). This shows that C8 may be embedded in various polymer matrices and still exhibit the photoluminescent properties.

FIG. 9A shows the PMMA/C8 fibres at 0 days, i.e. on the day of fabrication, while FIG. 9B shows the same fibres at 80 days after being stored under ambient laboratory conditions. This indicates that the fibres are stable after 80 days without requiring any special storage conditions.

Alternatively as above, poly(N-isopropylacrylamide) (polyNIPAM; 40000 Da) polymers was used with 4 mg of C8 at a weight ratio of C8 to polyNIPAM of 1:75 in 5 mL of ethanol. FIG. 10 shows a SEM image of electrospun nanofibres from a spinable ethanol solution containing poly(N-isoproylacrylamide) polymer and C8.

FIG. 11 shows the photoluminescence of the fibre made from polyNIPAM and C8. Although the PVP and polyNIPAM polymer matrix to C8 weight ratio was maintained at 75:1 (w/w), the photoluminescence response varied by a factor of 63. This indicates that although different polymer matrices may be used, the interaction between C8 and the polymer matrix plays a role in the observed photoluminescence.

The weight percentages for C8 and the polymer have varied from 0.10% (w/w) for C8 to 7.6% (w/w) for the polymer with respect to the solvent. The concentration of C8 was diluted by 10 and 25 times. The concentration of C8 and photoluminescence shows a linear correlation (FIG. 11).

The examples above show that photoluminescent molecules, as exemplified by C8, may display low photoluminescence when dissolved in a solvent, like ethanol, but can exhibit strong phosphorescence in an electrospun nanofibre when stimulated with UV light. The excitation and emission wavelength of the photoluminescent molecules may be tweaked by varying the structure, in particular the substituents in the hydrophobic portion, i.e. R₁ to R₅. In addition, the choice of the polymer may also affect the photoluminescence due to the interaction between the photoluminescent molecules and the polymer matrix.

The method allows incorporation of aggregation induced emission photoluminescent molecules into a variety of polymeric matrices, such as PVP, PVDF-HFP, PMMA and polyNIPAM, readily using various solvents. Electrospun fibres with smooth morphology may be readily and rapidly fabricated without the need of chemical modification of the polymers (for example to tether AIE-active pendants into the polymeric backbone) and with minimal concerns in solubility. The Raman and UV-Vis spectra revealed that the molecular integrity of the photoluminescent molecules remains intact within the polymeric electrospun nanofibers after electrospinning. The fluorescence emission spectrum indicated a strong and uniformed photoluminescence when excited with λₑₓ=254 nm and λₑₓ=365 nm, while the lifetime photoluminescence studies suggest the nanofibers follow a phosphorescent energy emission pathway. Different photoluminescent molecules and polymers may be used to make the electrospun fibres to provide fibres with different characteristics, in particular different photoluminescence properties and allows for tuning of the photoluminescence properties for different requirements. The electrospun fibres may be used in the digital manufacturing and design of smart textiles.

### REFERENCES

1. E. P. Tomlinson, M. E. Hay, B. W. Boudouris, Macromolecules. 2014, 47, 6145.
2. B. Z. Tang, Macromol. Chem. Phys. 2009, 210, 900.
3. H. Wang, E. Zhao, J. W. Y. Lam, B. Z. Tang, Mater. Today. 2015, 18, 365.
4. S. Rafiei, Electrospinning process: a comprehensive review and update. In Applied methodologies in polymer research and technology, Abbas Hamrang; Devrim Balkose, Eds. Apple academic press: 2014; 1.
5. J.-T. Wang, Y. C. Chiu, H. S. Sun, K. Yoshida, Y. Chen, T. Satoh, T. Kakuchi, W.-C. Chen, Polym. Chem. 2015, 6, 2327.
6. C.-C. Kuo, C.-H. Lin, W. C. Chen, Macromolecules. 2007, 40, 6959.
7. H. C. Chen, C.-L. Liu, C.-C. Bai, N.-H. Wang, C.-S. Tuan, W.-C. Chen, Macromol. Chem. Phys. 2009, 210, 918.
8. H.-J. Yen, C.-J. Chen, G. S. Liou, Chem. Commun. 2013, 49, 630.
9. H.-J. Yen, J.-H. Wu, W.-C. Wang, G.-S. Liou, Adv. Optical Mater. 2013, 1, 668.
10. Y. Hung-Ju, G.-S. Liou, Chem. Commun. 2013, 49, 9797.
11. L. Zhao, Y. Chen, J. Yuan, M. Chen, H. Zhang, X. Li, ACS Appl. Mater. Interfaces. 2015, 7, 5177.
12. W. Yuan, P.-Y. Gu, C.-J. Lu, K.-Q. Zhang, Q.-F. Xu, J-M. Lu, RSC Adv. 2014, 4, 17255.
13. T. Abitbol, J. T. Wilson, D. G. Gray, J. Appl. Polym. Sci. 2011, 119, 810.
14. B. Ortac, F. Kayaci, H. A. Vural, A. E. Deniz, T. Uyar, Reactive & functional polymers. 2013, 73, 1262.
15. Z. Liu, M. G. Helander, Z. Wang, Z. Lu, Z., J. Phys. Chem. C. 2010, 114, 11931.
16. Y. Ner, J. G. Grote, J. A. Stuart, G. A. Sotzing, Angew. Chem. Int. Ed. 2009, 48, 5134.
17. S.-Y. Min, J. Bang, J. Park, C.-L. Lee, S. Lee, J.-J. Park, U. Jeong, S. Kim, T.-W. Lee, RSC Adv. 2014, 4, 11585.
18. F. Anariba, L. L. Chng, L. N. S. Abdullah, F. E. H. Tay, J. Mater. Chem. 2012, 22, 19303.
19. L. Heng, X. Wang, Y. Dong, J. Zhai, B. Z. Tang, T. Wei, L. Jiang, Chem. Asian J. 2008, 3, 1041.
20. T. D. Klots, Spectrochemica Acta Part A. 1998, 54, 1481.
21. D. L. A.d Faria, H. A. C. Gil, A. A. A.d. Quieroz, J. Molecular Structure. 1999, 479, 93.
22. F. Anariba, U. Viswanathan, D. F. Bocian, R. L. McCreery, Anal. Chem. 2006, 78, 3104.
23. B. Z. Tang, X. Zhan, G. Yu, P. P. S. Lee, Y. Liu, D. Zhu, J. Mater. Chem. 2001, 11, 2974.
24. M. A. Pardo, J. M. Jimenez, M. A.d Valle, M. A. Godoy, F. R. Diaz, J. Chil. Chem. Soc. 2014, 59, 2464.

1. An electrospun fibre comprising:
(a) a polymer matrix; and
(b) a plurality of photoluminescent molecules in the polymer matrix,
wherein each photoluminescent molecule comprises a hydrophobic portion and a charged portion.

2. The electrospun fibre according to claim 1, wherein the charged portion is hydrophilic or hydrophobic.

3. The electrospun fibre according to any one of claim 1 or 2, wherein the hydrophobic portion has a general Formula (I): 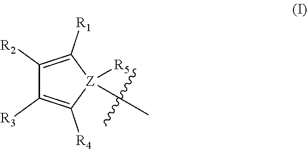
wherein R₁, R₂, R₃, and R₄ is each independently an aryl group, a substituted aryl group, a heteroaryl group, or a substituted heteroaryl group; R₅ is an aryl group, a substituted aryl group, a heteroaryl group, a substituted heteroaryl group, a hydrogen or an alkyl group; and Z is carbon or silicon.

4. The electrospun fibre according to claim 3, wherein R₅ is an aryl group, a substituted aryl group, a heteroaryl group, or a substituted heteroaryl group.

5. The electrospun fibre according to claim 3, wherein R₁ to R₅ is a phenyl group.

6. The electrospun fibre according to any one of claims 1 to 5, wherein the charged portion is a pyridinium cation.

7. The electrospun spun fibre according to claim 6, wherein the photoluminescent molecule further comprises a counterion to the charged portion.

8. The electrospun fibre according to any one of claims 1 to 7, further comprising a linker for linking the charged portion to the hydrophobic portion, wherein the linker is any one selected from the group comprising: —X(CH₂)ₙ—, —X(CH₂)ₙY—, —(CH₂)ₙ—, and —(XCH₂CH₂)ₙ—, wherein n is an integer from 3 to 20, X and Y are independently oxygen, nitrogen or sulpur.

9. The electrospun fibre according to any one claims 1 to 8, wherein the polymer matrix comprises any polymer selected from the group comprising: polyvinylpyrrolidone, poly(N-isopropylacrylamide), poly(vinylidene fluoride)-co-hexafluoropropylene, and poly(methyl methacrylate).

10. The electrospun fibre according to any one of claims 1 to 9, wherein the plurality of photoluminescent molecules form an aggregate nanoparticle having a diameter between about 5 to 800 nm.

11. The electrospun fibre according to any one of claims 1 to 10, wherein the weight ratio of the plurality of photoluminescent molecules to the polymer is about 1:1875 to about 1:75.

12. The electrospun fibre according to any one of claims 1 to 10, further comprising epoxy.

13. The electrospun fibre according to any one claims 1 to 12, wherein the plurality of photoluminescent molecules exhibit a phosphorescence half-life greater than or equal to one nanosecond.

14. The electrospun fibre according to any one claims 1 to 13, wherein the plurality of photoluminescent molecules exhibit a phosphorescence half-life greater than or equal to one microsecond.

15. A method for producing an electrospun fibre, the method comprising:
(a) preparing a polymer matrix;
(b) adding a plurality of photoluminescent molecules to the polymer matrix to form a spinable solution, each photoluminescent molecule comprises a hydrophobic portion and a charged portion; and
(c) electrospinning the spinnable solution to produce the electrospun fibre.

16. The method according to claim 15, wherein the polymer matrix and plurality of photoluminescent molecules are mixed in a solvent to prepare the spinnable solution.

17. The method according to claim 15, wherein the plurality of photoluminescent molecules are mixed in a solvent prior to being added into the polymer matrix.

18. The method according to claim 17, wherein the polymer matrix is in a second solvent.

19. The method according to any one of claims 16 to 18, wherein the solvent and/or second solvent is an organic solvent, water, or a combination of an organic solvent and water.

20. The method according to 18, wherein the organic solvent is any one selected from the group comprising: DMSO, DMF, acetone, and an alcohol.

21. The method according to claim 15, wherein the polymer matrix is polyvinylpyrrolidone and the spinable solution is in ethanol.

22. The method according to any one of claims 15 to 21, wherein the spinable solution in step (b) is stirred for 30 minutes to 24 hours at a temperature between 20° C. to 100° C.

23. The method according to claim 22, wherein the temperature is between 20° C. to 50° C.

24. The method according to any one of claims 15 to 23, further comprising drying the electrospun fibre.

25. The method according claim 24, wherein drying is carried out in an oven at 60° C. for 2 hours.
